(19) United States
(12) Patent Application Publication
(10) Pub. No.: US 2002/0032764 A1
(43) Pub. Date: Mar. 14, 2002

(54) Technology for managing trouble creating devices in a network

(75) Inventors: Katsutoshi Ishikawa, Kanagawa (JP); Hironao Tokitsu, Kanagawa (JP)

Correspondence Address: SUGHRUE, MION, ZINN, MACPEAK & SEAS, 2100 Pennsylvania Avenue, N.W., Washington, DC, 20037, US

(73) Assignee: ROUTREK NETWORKS, INC.

(21) Appl. No.: 09/888,376

(22) Filed: Jun. 26, 2001

(30) Foreign Application Priority Data
Sep. 4, 2000 (JP) 2000-267137

(51) Int. Cl. G06F 15/173

(52) U.S. Cl. 709/223; 709/206

(57) ABSTRACT

The network management system includes the electronic message generating unit that generates an electronic message from a status of a monitored unit which may generate a trouble; and the arranging unit that analyzes the contents of the electronic message generated by the electronic message generating unit, determines a seriousness level of the trouble, determines a destination of an electronic message according to the seriousness level and a time and date of an occurrence, adds causes and/or countermeasures of the trouble to the electronic message, and transmits the electronic message to the destination.

### FIELD OF THE INVENTION

The present invention relates to a network management system capable of monitoring (as well as observing) a unit that may generate a trouble in a network, informing the operator, engineer or expert about the trouble when the trouble has occurred thereby promoting rapid attention to the trouble. The devices that need to be monitored are routers, switches, firewalls, etc.

### BACKGROUND OF THE INVENTION

Conventionally, a network management system having a monitoring unit is provided in a network (including a unit connected to the network). The monitoring unit employs a polling method called an SNMP (Simple Network Management Protocol) for processing trouble when there occurs a trouble in the network. The monitoring unit informs about the trouble to an operator in the form of an electronic mail or a notification message. The operator classifies the trouble, and analyzes and processes the trouble. When the operator cannot solve the trouble, the operator requests help from an engineer or an expert who has more knowledge and experience.

The operator here means a person or manager who manages the network. The operator has a thorough knowledge of the layout and the setting of devices in the field. The engineer is a maintenance person familiar with a mechanism and operation of the devices themselves that constitute the network, but is not fully familiar with the layout and the setting of devices in the field. For example, a maintenance person of a system integration company that delivered the devices corresponds to this engineer. Further, an expert is an engineer who is fully familiar with an internal structure of a device, and the expert corresponds to a maintenance person of a device manufacturing company that manufactured this device, for example.

FIG. 15 shows a workflow in a conventional general network management system.

An operation generation source 1 generates a job of an operation that an operator must execute, and an associated operation generation source 2 generates a job of an associated operation other than the operation of the operator. These jobs are accumulated as a queue for the operator. The operator takes out a job from this queue 3 for the operator, and processes this job at a first stage 4.

The operation generation source 1 has means that monitors a unit to be monitored like a device in the network management system, and generates an operation job that is necessary depending on the monitored status. The operation generation source 2 has means for generating other operation job. These means are structured by a computer program.

When the operator is unable to process a job, the job is transferred to a job queue 5 for the engineer as indicated by an arrow mark. Job requests from a plurality of operators are entered into the queue 5 for the engineer. The engineer takes out a job from this queue 5, and processes this job at a second stage 6.

When the engineer is unable to process a job, the job is transferred to a job queue 7 for the expert as indicated by an arrow mark. Job requests from a plurality of engineers are entered into the queue 7 for the expert. The expert takes out a job from this queue 7, and processes this job at a third stage 8.

As explained above, the operator processes jobs that the operator is able to process at the first stage 4. In addition to this, the operator processes jobs that have been processed by the expert at the third stage 8 or at a fourth stage 9 as post-processing. Moreover, the operator processes jobs that have been processed by the engineer at the second stage 6 or at a fifth stage 10 as post-processing.

In the conventional system, there is a drawback that, if a job related to trouble processing occurs and if the operator is away from the monitoring unit from which the operator monitors the system, the operator cannot take countermeasures against the trouble. On the other hand, when the operator is near the monitoring unit and if a job related to trouble processing occurs, the operator searches the meaning of a trouble message in a manual or an explanation document, and recognizes a position of the trouble, magnitude of seriousness (seriousness level), or possible causes, and measures against the causes. Further, the operator verifies assumed causes by executing a command of the monitored unit or based on a research of the history.

According to the conventional network management system, in order to find a trouble as fast as possible, the operator must always watch the monitoring unit for any electronic mail or message indicating the trouble. In other words, the operator cannot move away from the monitoring unit or do other work because that will lead to a delay in giving attention to the trouble. Therefore, it is necessary to provide an operator who will exclusively watch the monitoring unit. However, this disadvantageously increases the management reduces the productivity.

Further, the operator is required to search the manuals for understanding the meaning of the message displayed on the monitor unit, judge the seriousness level of the trouble, and determine a measure for solving the problem or request help from an engineer or expert. Thus, the operator must carry out a series of work for tackling the problem. As a result, this method has had a problem in that it is difficult to promptly take action for solving the trouble.

Further, depending on the trouble, the operator must request help from an engineer or expert. In this case, the operator has to make decision on whether to take help from the engineer or expert, which is time taking work. If the operator decides to take help from the engineer or expert, the operator is required to create documents that will help the engineer or expert solve the trouble, which is time taking too. This eventually lowers the efficiency.

### SUMMARY OF THE INVENTION

It is an object of the present invention to provide a technology for quickly processing troubles occurring in network systems. It is another object to provide a technology of monitoring and handling the troubles even if the operator is not near the monitoring unit.

The network management system according to one aspect of this invention comprises a monitored unit that may generate trouble in a network, said monitored unit transmitting a first electronic message indicating its own status; an electronic message generating unit that receives the message from said monitored unit and generates a second electronic message based on the message from said monitored unit; and an arranging unit. This arranging unit receives the electronic message from said electronic message generating unit, analyzes the contents of this electronic message, determines a seriousness level of the trouble, determines a destination of a third electronic message for informing about the trouble based on the determined seriousness level, time and date of occurrence of the trouble, determines causes and/or countermeasures of the trouble, creates the third electronic message that contains information that trouble has occurred, causes and/or countermeasures of the trouble, and transmits the third electronic message to the determined destination.

Thus, when the electronic message generating unit has detected a trouble of the monitored unit or when the electronic message generating unit has received a trouble message generated from the monitored unit, the electronic message generating unit generates an electronic message from this message, and posts this to the arranging unit. The arranging unit analyzes the contents of this electronic message, automatically makes a decision about a level of a maintenance person who should handle the work, and transmits the electronic message by electronic mail, for example. The arranging unit automatically adds a message including a cause of the trouble and a countermeasure, to this electronic mail.

The maintenance persons can carry out their works in parallel that have conventionally been carried out sequentially. Moreover, maintenance persons can quickly analyze troubles instead of the conventional method of analyzing problems based on the manual. As a result, it is possible to reduce the time required from an occurrence of a trouble to a recovery from the trouble, in the total work of the network management.

As explained above, according to the present invention, a cause of a trouble and a countermeasure are added to a message from the monitored unit, and an electronic message created as a result is posted in real time. Based on this method, it is possible to reduce the time required for the operator to analyze the trouble and arrange the work. Further, it is possible to dynamically change making arrangement to a plurality of managers and maintenance persons according to a seriousness level of each trouble so that the troubles are handled in parallel. As a result, it is possible to reduce the time required for recovering from troubles.

The arranging unit according to another aspect of this invention comprises a knowledge database which stores information about cause, countermeasure, and trouble analysis rules corresponding to the contents of an electronic message regarding a trouble or an alarm posted from a monitored unit that can generate a trouble in a network; a history database which stores information about history of messages generated in the past from the monitored unit; and an arrangement database which stores information about a plurality of postal destinations that are different depending on an occurrence time of the trouble or an alarm and the contents of the message.

The network management method according to still another aspect of this invention comprises the steps of monitoring a status of a monitored unit that can generate a trouble in a network; generating a first electronic message based on the monitored status of said monitored unit; determining a seriousness level of the trouble by analyzing the contents of the first electronic message; determining a destination of a second electronic message for informing about the trouble based on the determined seriousness level, time and date of occurrence of the trouble; determining causes and/or countermeasures of the trouble; creating the third electronic message that contains information that trouble has occurred, causes and/or countermeasures of the trouble; and transmitting the third electronic message to the determined destination.

The computer readable recording medium according to still another aspect of the present invention stores a computer program which when executed realizes the method according to the present invention.

Other objects and features of this invention will become apparent from the following description with reference to the accompanying drawings.

### BRIEF DESCRIPTION OF THE DRAWINGS

FIG. 1 is a diagram showing an example of a structure of a network management system according to the present invention;

FIG. 2 is a diagram showing a structure and a processing operation of an arranging unit in the system shown in FIG. 1;

FIG. 3 is a diagram showing one example of the contents of a knowledge database;

FIG. 4 is a diagram showing one example of the contents of a history database;

FIG. 5 is a diagram showing one example of the contents of an arrangement database;

FIG. 6 is a diagram showing one example of the contents of a database that expresses a correspondence between a monitored unit and an electronic message generating unit in the arranging unit;

FIG. 7 is a diagram showing one example of types of information included in an electronic mail to be transmitted from the electronic message generating unit to the arranging unit;

FIG. 8 is a diagram showing one example of types of information included in an electronic mail to be transmitted from the arranging unit to network managers like an operator, an engineer, and an expert;

FIG. 9 is a diagram showing one example of a display screen for reading a history of past occurrences of troubles of an optional monitored unit in the arranging unit;

FIG. 10 is a flowchart showing one example of an operation when a search button has been depressed on the display screen of FIG. 9;

FIG. 11 is a diagram showing a workflow according to the system of the present invention;

FIG. 12 is a diagram showing a detailed example of a message created by the electronic message generating unit when an error message has been obtained;

FIG. 13 is a diagram showing a detailed example of a message created by the arranging unit;

FIG. 14 is a diagram showing a detailed example of a display screen that can be read in the Web browser; and

FIG. 15 is a diagram showing a workflow according to a conventional system.

### DESCRIPTION OF THE PREFERRED EMBODIMENTS

Preferred embodiments of the present invention will be explained below with reference to the accompanying drawings.

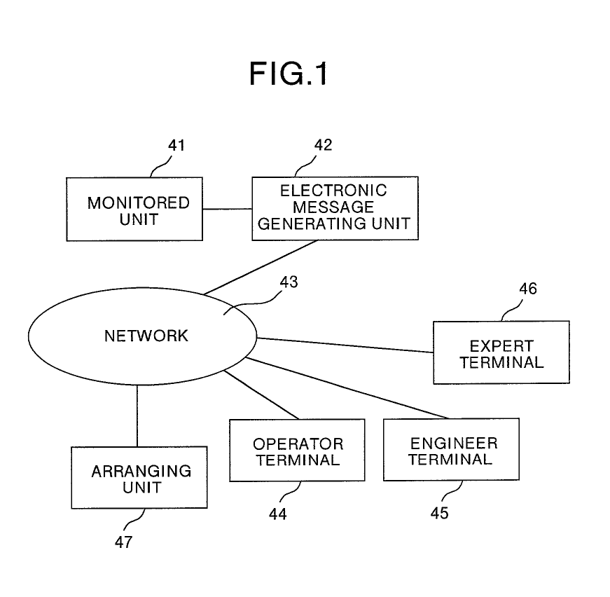

FIG. 1 is a diagram showing an example of a structure for realizing a network management system according to the present invention. The system shown in the drawing consists of the unit to be monitored (“monitored unit”) 41 for occurrence of any trouble, electronic message generating unit 42, network 43, a terminal operated by an operator (“operator terminal”) 44, a terminal operated by an engineer (“engineer terminal”) 45, a terminal operated by an expert (“expert terminal”) 46, and an arranging unit 47.

The monitored unit 41 may be the network servers, routers, observing units, control units, or any other devices in the network.

The electronic message generating unit 42 obtains a message that the monitored unit 41 outputs from a local console. Then, the electronic message generating unit 42 generates an electronic message based on this message, and posts it by electronic mail or the like. Alternatively, the electronic message generating unit 42 has a function of monitoring the monitored unit 41, and detecting a trouble or other abnormal condition. When the electronic message generating unit 42 has found an abnormal condition, it generates an electronic message regarding the occurrence of this abnormality, and posts this message.

The network 43 may be the Internet, and communication path and communication lines like a telephone network, a portable telephone network, and a pager network. Based on this structure, the network 43 makes it possible to communicate between the monitored unit 41, the electronic message generating unit 42, the operator terminal 44, the engineer terminal 45, the expert terminal 46, and the arranging unit 47 with each other.

The operator terminal 44 may be any device, such as a personal computer or a portable telephone (mobile telephone), that can be connected to the network 43. The operator receives messages that inform occurrence of trouble on this operator terminal 44 and remote control the monitored unit 41 to process the trouble.

The engineer terminal 45 may be any device, such as a personal computer or a portable telephone, that can be connected to the network 43. The engineer receives messages that inform occurrence of trouble on this engineer terminal 45 and remote control the monitored unit 41 to process the trouble.

The expert terminal 46 may be any device, such as a personal computer or a portable telephone, that can be connected to the network 43. The expert receives messages that inform occurrence of trouble on this expert terminal 45 and remote control the monitored unit 41 to process the trouble.

The arranging unit 47 analyzes an electronic message received from the electronic message generating unit 42. Furthermore, the arranging unit 47 determines destination of the message according to seriousness level of the trouble that occurred and the date and time of the occurrence of the trouble. Furthermore, the arranging unit 47 generates a message that contains the cause of occurrence of the trouble and countermeasure of the trouble. Furthermore, the arranging unit 47 transmits this message in the form of an electronic mail. The arranging unit 47 has a work knowledge of troubles, and automatically arranges the work by electronic mail and collects data necessary for analyzing the trouble at the same time. Depending on the situation, the arranging unit 47 automatically analyzes the trouble based on the collected data, and presents a result of the analysis to the operator, the engineer, and the expert.

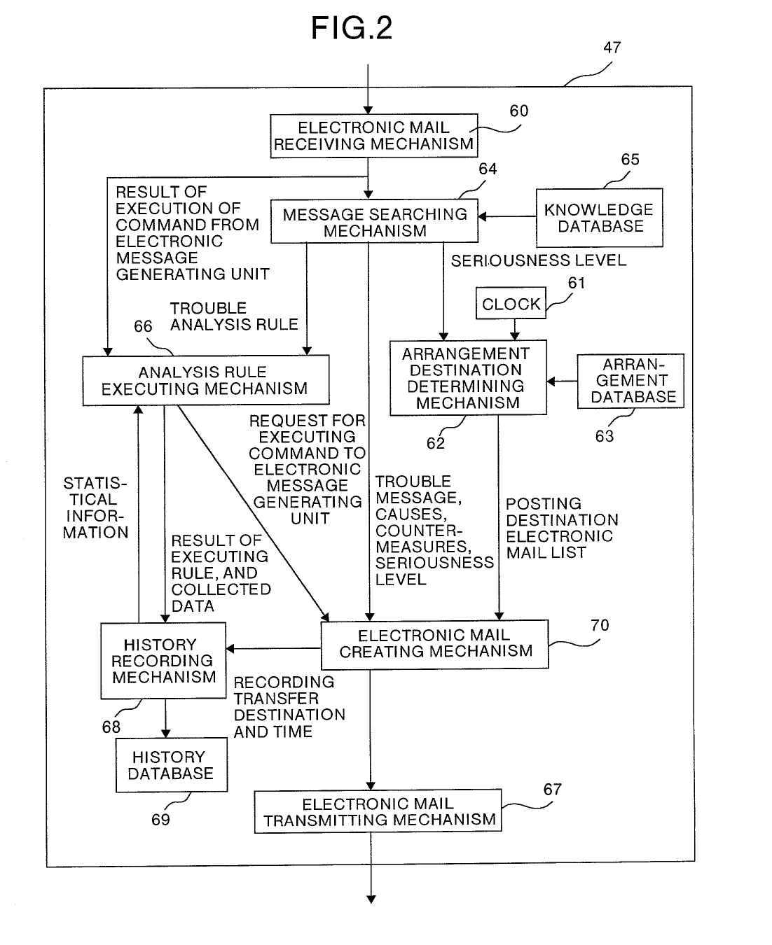

FIG. 2 shows a structure and a processing operation of the arranging unit 47. The arranging unit 47 is comprised of the electronic mail receiving mechanism 60, clock 61 for generating a date and time, arrangement destination determining mechanism 62, arrangement database 63, message searching mechanism 64, knowledge database 65, analysis rule executing mechanism 66, electronic mail transmitting mechanism 67, history recording mechanism 68, history database 69, and electronic mail creating mechanism 70. These mechanisms are realized through the execution of a predetermined program by hardware like a computer.

The arrangement destination determining mechanism 62 determines which work is to be arranged to which manager (arrangement destination), based on an index that expresses a seriousness level transmitted from the message searching mechanism 64 and a current time transmitted from the clock 61. The arrangement destination determining mechanism 62 searches the arrangement database 63 for this determination.

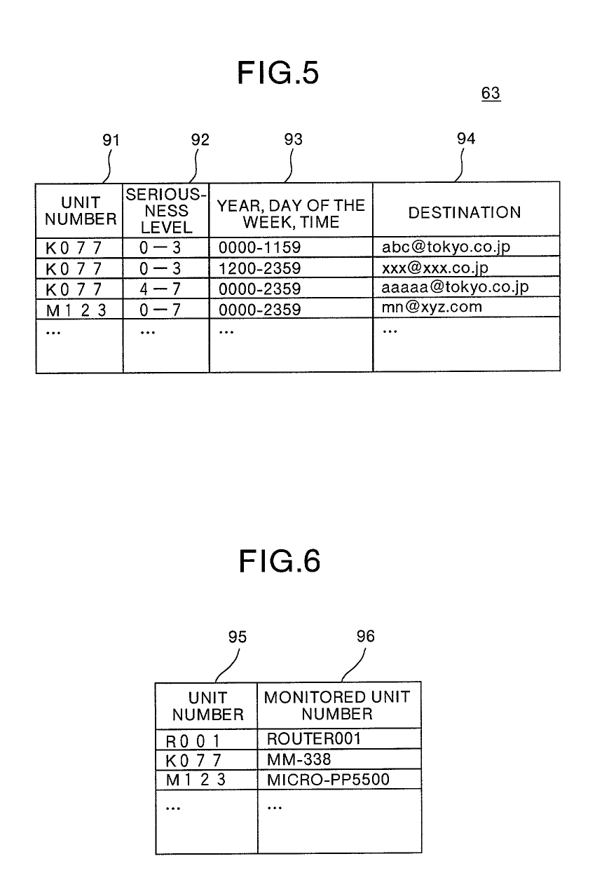

As shown in FIG. 5, the arrangement database 63 stores destination information for transmitting by electronic mail a seriousness level of a trouble and a date and time of the occurrence of the trouble each time when a trouble has occurred, for each electronic message generating unit 42. Specifically, the arrangement database 63 stores a unit number into a field 91, and stores a seriousness level into a field 92, like “0-3” when the seriousness level is equal to or above 0 and equal to or less than 3, for example. The arrangement database 63 stores a time zone including a year and a month into a field 93, like “0000-1159” when the time is from 0 o'clock 0 minutes to 12 o'clock 0 minutes everyday, for example. Further, the arrangement database 63 stores a mail address of an electronic mail, for example, as an address, into a field 94.

The message searching mechanism 64 determines a seriousness level index that expresses the seriousness level of a trouble, a plurality of possible causes and countermeasures, and an accompanying analysis rule of the trouble, based on a trouble message within the electronic mail.

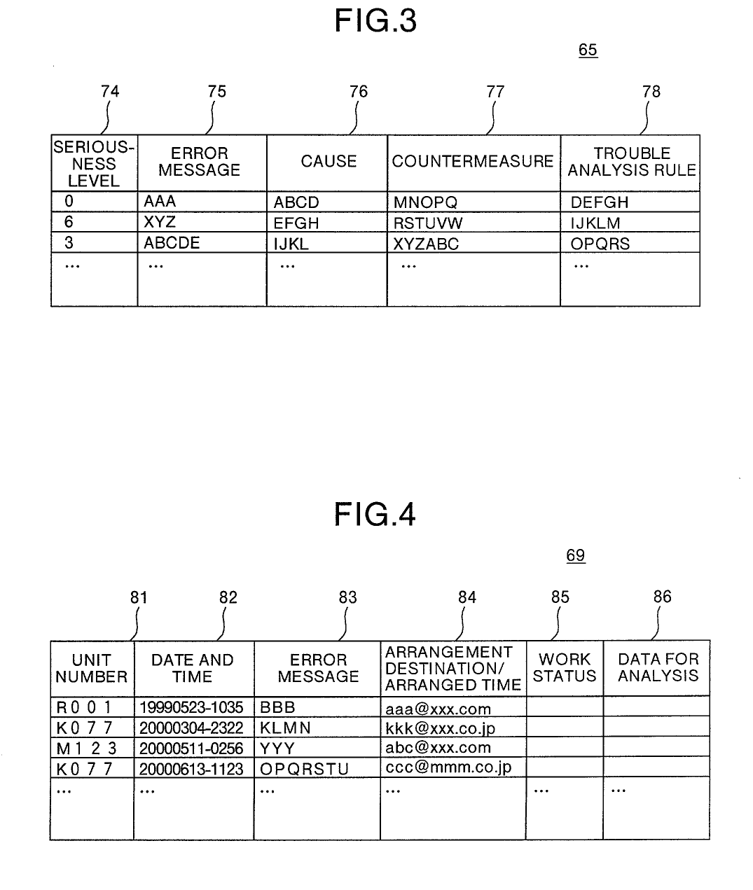

The knowledge database 65 stores items that the message searching mechanism 64 searches for, and has a structure as shown in FIG. 3. In other words, the knowledge database 65 stores a seriousness level of a trouble that an error message expresses, like a numerical value from 0 to 7 (a higher seriousness level when the value is small), for example, into a “seriousness level” field 74. The knowledge database 65 stores an error message into an “error message” field 75, and stores a plurality of possible causes of a trouble in the order of high frequency, into a “cause” field 76. Further, the knowledge database 65 stores a plurality of possible countermeasures of a trouble in the order of high frequency, into a “countermeasure” field 77, and stores data to be collected and analysis procedures for specifying a cause of a trouble, into a “trouble analysis rule” field 78.

Referring back to FIG. 2, the analysis rule executing mechanism 66 executes a trouble analysis rule obtained from the message searching mechanism 64, and transmits by electronic mail a data collection instruction to the electronic message generating unit 42 to collect data necessary for the analysis, depending on the needs. If possible, the analysis rule executing mechanism 66 estimates a cause of the trouble.

The history recording mechanism 68 records a trouble message together with an occurrence time, an arrangement destination, a work status, and analysis data of the trouble. This statistical information is used for the analysis rule executing mechanism 66 to analyze the cause as well. When the analysis rule executing mechanism 66 has issued a data collection instruction to the electronic message generating unit 42, a response to this request is transmitted to the history recording mechanism 68 from the electronic mail receiving mechanism 60. The history recording mechanism 68 stores necessary information into the history database 69.

The history database 69 is structured as shown in FIG. 4. This history database 69 stores a unit number included within an electronic message received from the electronic message generating unit 42, into a field 81. In this case, the unit number is a serial number allocated in advance to the electronic message generating unit 42 connected to each of a plurality of monitored units 41 connected to the network.

The history database 69 stores a date and time of transmission of an electronic message included in this message received from the electronic message generating unit 42, such as “19990523-1035” that expresses May 23, 1999 at 10 o'clock 35 minutes, for example, into a field 82.

The history database 69 stores an error message included in an electronic message received from the electronic message generating unit 42, into a field 83.

The history database 69 stores an arrangement destination arranged by the arranging unit 47 and a time of this arrangement, into a field 84.

The history database 69 stores a current work status that shows whether the manager is currently processing or has finished processing, into a field 85.

The history database 69 stores a result of a series of commands that the electronic message generating unit 42 has executed at the request of the analysis rule executing mechanism 86, into a field 86 of collected data that is necessary for analyzing the trouble.

Referring back to FIG. 2, the electronic mail creating mechanism 70 creates an electronic mail to be posted to the manager. This electronic mail is created based on the information from the message searching mechanism 64, the arrangement destination determining mechanism 62, and the analysis rule executing mechanism 66. Moreover, the electronic mail creating mechanism 70 delivers data to the history recording mechanism 68 for recording the contents.

FIG. 6 shows one example of the contents of a database, stored in the arranging unit 47, that expresses a correspondence (a combination of connection) between the monitored unit 41 and the electronic message generating unit 42.

The arranging unit 47 holds as a database, the information that expresses which electronic message generating unit 42 has been connected to which monitored unit 41. Specifically, the arranging unit 47 stores a unit number into a field 95, and stores a serial number and a name of a monitored unit that enables the manager to uniquely recognize one monitored unit 41 among a plurality of monitored units.

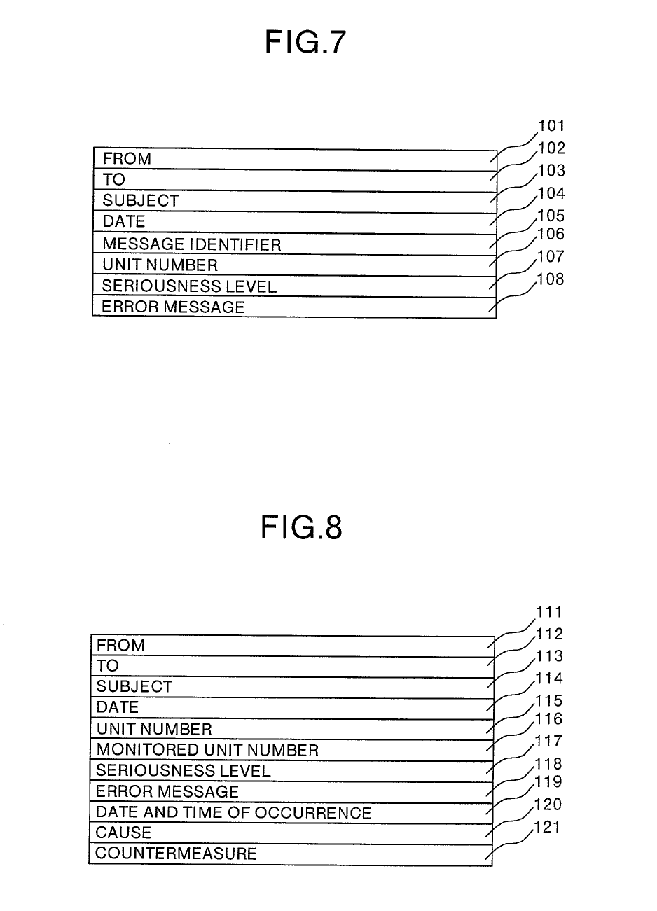

Operation of the arranging unit 47 will now be explained. First, the electronic mail receiving mechanism 60 receives an electronic message from the electronic message generating unit 42. This electronic mail includes information as shown in FIG. 7, for example. These items of information exist within the electronic mail in the text format, for example. It is possible to take out each information element by matching a header character string at the header and a specific character string.

FIG. 7 shows one example of types of information included in an electronic mail to be transmitted from the electronic message generating unit 42 to the arranging unit 47. “From” field 101 has information that expresses a mail address allocated in advance to the electronic message generating unit 42. “To” field 102 has information that expresses a mail address allocated in advance to the arranging unit 47. “Subject” field 103 has information that expresses a mail title generally included in the electronic mail. “Date” field 104 has information that expresses a date and time at the point of time when an electronic mail is transmitted. “Message identifier” field 105 has an identifier that uniquely identifies an electronic mail. “Unit number” field 106 has information that expresses a serial number allocated in advance to each electronic message generating unit 42.

Further, “Seriousness level” field 107 has a seriousness level of a trouble shown by an error message included as the contents of an electronic mail transmitted from the electronic message generating unit 42. This seriousness level is expressed in a numerical value of 0 to 7 (a smaller value has a larger seriousness level), for example. “Error message” field 108 has information that expresses an error message showing a trouble of the monitored unit 41 detected by the electronic message generating unit 42.

The electronic mail receiving mechanism 60 transmits this electronic mail to the message searching mechanism 64 for the next processing. The message searching mechanism 64 extracts the error message (field 108) from the contents (see FIG. 7) of the received electronic mail, and searches the knowledge database 65 using this error message as a key. Then, the message searching mechanism 64 obtains the seriousness level (field 74), the cause (field 76), the countermeasure (field 77), and the trouble analysis rule (field 78) of the contents (see FIG. 3). Out of these items of information, the seriousness level (field 74), the error message (field 75), the cause (field 76), and the countermeasure (field 77) are transmitted to the electronic mail creating mechanism 70. The trouble analysis rule (field 78) is transmitted to the analysis rule executing mechanism 66. Moreover, the seriousness level (field 74) is transmitted to the arrangement destination determining mechanism 62.

The analysis rule executing mechanism 66 executes the trouble analysis rule (field 78), and estimates a cause of the trouble. Further, the analysis rule executing mechanism 66 can also collect data for estimating a cause. In this case, the analysis rule executing mechanism 66 transmits an electronic mail to the electronic message generating unit 42 to instruct the electronic message generating unit 42 to obtain data necessary for the analysis. The data for estimating a cause is transmitted from the electronic message generating unit 42 to the analysis rule executing mechanism 66 again via the electronic mail receiving mechanism 60.

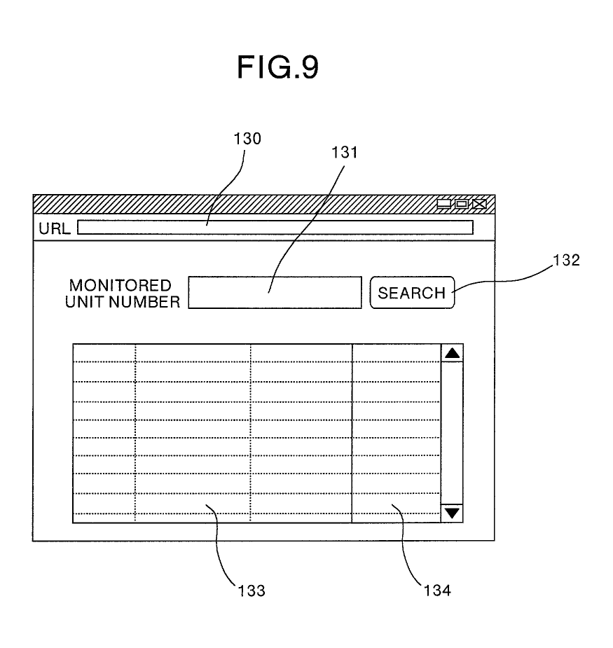

The data relating to the estimate of a cause carried out by the analysis rule executing mechanism 66 is transmitted to the history recording mechanism 68. When the operator, the engineer or the expert makes a decision about a cause, a screen as shown in FIG. 9 to be described later is displayed. The operator or the engineer or the expert verifies these displayed items, and specifies a cause.

On the other hand, the arrangement destination determining mechanism 62 obtains the seriousness level (field 107) from the electronic mail information shown in FIG. 7, and obtains current time information from the clock 61. Then, the arrangement destination determining mechanism 62 searches the contents (see FIG. 5) of the arrangement database 63, and obtains a destination (field 94) to which it is suitable to post the trouble. The information of this destination (field 94) is transmitted to the electronic mail creating mechanism 70.

The electronic mail creating mechanism 70 obtains the monitored unit number (field 96) from the database (see FIG. 6) of the arranging unit 47 by using the unit number (field 106) of the electronic mail information of FIG. 7 as a key. Moreover, the electronic mail creating mechanism 70 creates an electronic mail (see FIG. 8) to be transmitted to the manager, by using the error message (field 75), the cause (field 76), the countermeasure (field 77), and the data for estimating a cause, shown in FIG. 3.

FIG. 8 shows one example of types of information included in an electronic mail to be transmitted from the arranging unit 47 to the network managers like the operator, the engineer, and the expert.

“From” field 111 has information that expresses a mail address allocated in advance to the arranging unit 47. “To” field 112 has information that expresses a mail address allocated in advance to the manager of a transmission destination. “Subject” field 113 has information that expresses a mail title generally included in the electronic mail. “Date” field 114 has information that expresses a date and time at the point of time when an electronic mail is transmitted. “Unit number” field 115 has information that expresses a serial number allocated in advance to each electronic message generating unit 42. “Monitored unit number” field 116 has information that expresses a serial number and a name allocated to each monitored unit to enable the manager to know how many monitored units 41 exist that the electronic message generating unit 42 having the unit number shown in the unit number field 115 is monitoring. “Seriousness level” field 117 has information that expresses the seriousness level (field 107) of a trouble shown by an error message received from the electronic message generating unit 42. “Error message” field 118 has information that expresses the error message (field 108) received from the electronic message generating unit 42. “Date and time of occurrence” field 119 has information that expresses the “Date” field 104 included in the electronic mail (see FIG. 7) received from the electronic message generating unit 42.

When the electronic message generating unit 42 has detected a trouble of the monitored unit 41, the electronic message generating unit 42 immediately creates an electronic mail and transmits this mail to the arranging unit 47. Therefore, in the present embodiment, it is possible to consider that the information shown in the “date and time of occurrence” field 119 is the date and time of the occurrence of a trouble.

“Cause” field 120 has information that expresses a cause of a trouble shown in the error message (field 108) posted from the electronic message generating unit 42. Causes are listed in the order of frequency. A “countermeasure” field 121 has information that expresses a countermeasure of a trouble shown in the error message (field 108) posted from the electronic message generating unit 42. Countermeasures are listed corresponding to the causes listed in the cause field 120.

In FIG. 8, the “From” information (field 111) is a mail address allocated to the own arranging unit 47. The “To” information (field 112) is a destination, and is also a mail address that has been determined by the arrangement destination determining mechanism 62. The “Subject” information (field 113) is a title of the electronic mail. This is an easy text like “error notice”, for example, that the receiver can immediately understand. The “Date” information (field 114) is current date and time.

The electronic mail created in the manner as described above is transmitted by the electronic mail transmitting mechanism 67 to a postal destination assigned by the arrangement destination determining mechanism 62. Data necessary for making record of a history is transmitted to the history recording mechanism 68.

According to the present embodiment, upon receiving a post from the arranging unit 47, a network manager like the operator, the engineer or the expert makes access to the information provided from the arranging unit 47, specifies a cause of a trouble and processes the trouble. In other words, the relevant managers share the information of the history database 69, and proceed with the processing. For example, by assigning a predetermined URL address on the Web browser application, the managers read the information in the history database 69 managed by the arranging unit 47, via the network 43.

FIG. 9 shows a screen for reading a history from the Web browser as one example of a display screen for reading a history of past occurrences of troubles (the contents of the history data base shown in FIG. 4) of an optional monitored unit 41 in the arranging unit 47.

The URL assignment column 130 is a URL assignment column of a general-purpose Web browser. By assigning a predetermined address in this URL assignment column 130, it is possible to start a program held by the arranging unit 47 thereby to read a history of past troubles.

The monitored unit number input column 131 is a column for inputting a monitored unit number of the monitored unit 41 to read a history of the past occurrence of troubles.

When the manager depresses a search button 132, a program held by the arranging unit is started so that it becomes possible to read a history of past troubles of the monitored unit 41 assigned in the monitored unit number input column 131.

The history display column 133 displays a history of past troubles in a predetermined format.

The field 134 that shows a process of execution shows in real time the electronic mail address of a destination, and a status of processing at the arrangement destination.

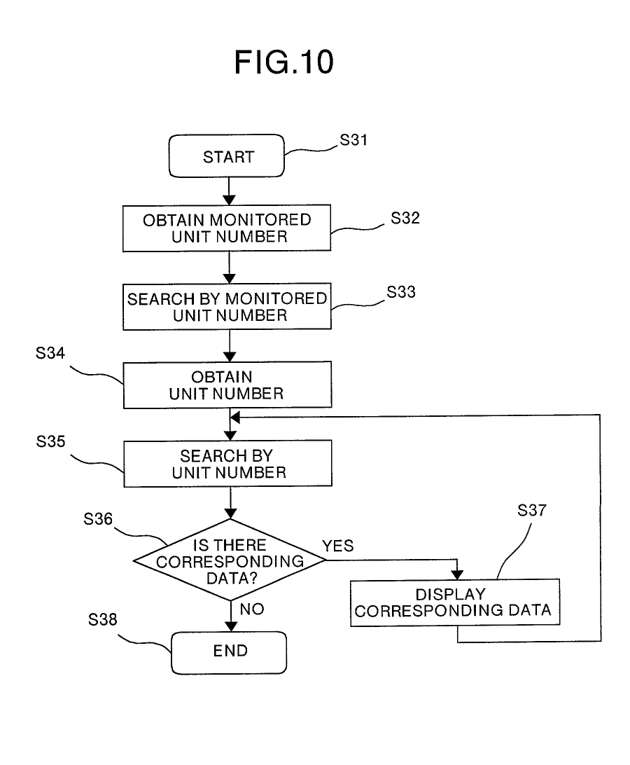

FIG. 10 is a flowchart showing one example of an operation when the search button 132 has been depressed on the display screen of FIG. 9.

When a monitored unit number of a monitored unit 41 has been into the monitored unit number input column 131 and then the search button 132 has been depressed on the screen shown in FIG. 9, the processing shown in the flowchart of FIG. 10 starts, and a start step S31 is called.

Next, the monitored unit number that has been input into the monitored unit number input column 131 is obtained (step S32). Then, the database of the arranging unit 47 (see FIG. 6) is searched using the monitored unit number obtained as a keyword (step S33). Based on this searching, the unit number (field 95) is extracted (step S34). Next, the contents of the historical database 69 (see FIG. 4) are searched using the obtained unit number as a keyword (step S35). As a result of this searching, a decision is made about whether there exists a corresponding data or not (step S36). When it has been decided as a result of this decision that there exists the corresponding data, this data is extracted. Then, the date (field 82), the error message (field 83), the arrangement destination (field 84) arranged by the arranging unit 47, and the data for analysis (field 86) are displayed on the history display column 133 as a history. Moreover, the work status (field 85) is displayed on the processing status display column 134 (step S37). This display is repeated at steps S36 and S37 as long as there exists the corresponding data. When there is no more corresponding data, this processing is finished (step S38).

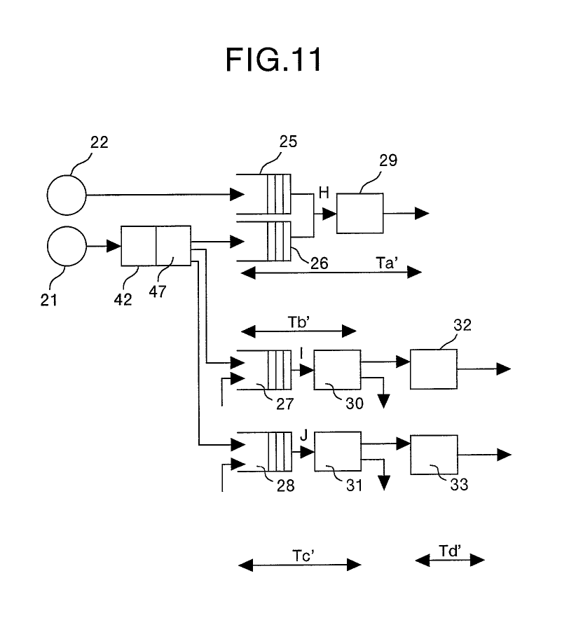

FIG. 11 shows an example of a workflow from when the operator, the engineer, and the expert have recognized an occurrence of a trouble in the monitored unit 41 till when the countermeasure of this trouble has been completed, in the network management system shown in FIG. 1.

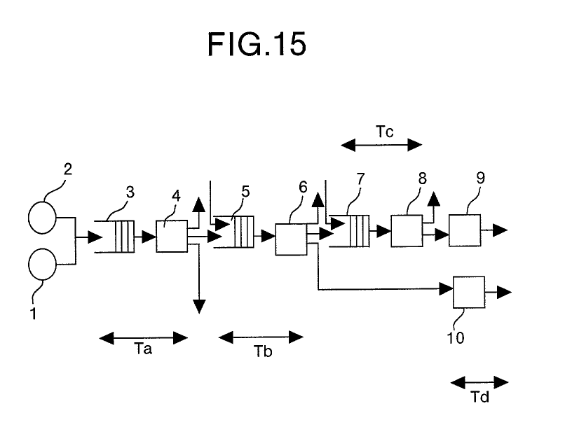

The operation generation source 21 generates an operation job that the operator must carry out. The associated operation generation source 22 generates an associated operation job other than the operation. These points are similar to those of the conventional system (see FIG. 15). However, in the system shown in FIG. 1, the monitored unit 41 structures a part or the whole of the operation generation source 21.

The operator takes out a job from an associated operation queue 25 using the operator terminal 44, and processes the job at a first stage 29, so long as there is no job from an operation generation source 21. When there is a job in an operation queue 26, the operator takes out the operation from the operation queue 26 with priority, and processes the job at the first stage 29, even when there is a job in the associated operation queue 25. When an operation has occurred, the operator suspends the processing of the associated operation, and immediately takes out the operation from the operation queue 26, and processes this operation.

The engineer takes out a job from an engineer queue 27, and carries out the job at a second stage 30. The expert takes out a job from an expert queue 28, and carries out the job at a third stage 31. The operator carries out a post-processing of the engineer job at a fourth stage 32, and carries out a post-processing of the expert job at a fifth stage 33.

As explained above, the electronic message generating unit 42 creates an electronic message for posting, based on a message output from the monitored unit 41 or based on a detection of an abnormality that has been detected by observing the monitored unit 41. The electronic message generating unit 42 also has a function of understanding or detecting a status of the monitored unit 41 by making the monitored unit 41 execute a command according to a request from a remote unit. These works are carried out by the jobs transmitted from the operation generation source 21 to the electronic message generating unit 42.

The arranging unit 47 analyzes the electronic message from the electronic message generating unit 42, and arranges operations in parallel by electronic mails. Moreover, the arranging unit 47 adds cause and countermeasure knowledge about the trouble included in the contents of the electronic message, to the electronic mail. Further, the arranging unit 47 has a function of collecting data that is necessary for the manager to analyze from the electronic message generating unit 42, based on the knowledge for analyzing the trouble.

The time from a detection of a trouble to a completion of the processing will be explained for the following three cases of (A) to (C).

Case (A): When only the Operator can Manage to Process a Trouble (the First Stage 29)

(1) The operator takes out a job from the associated operation queue 25 or the operation queue 26, as shown by an arrow mark H. The operator terminal 44 uses a portable terminal, to which the job of each queue is posted.

(2) When the job is an associated operation, the operator processes this job and finishes the work. On the other hand, when the job is a job of processing a trouble of the operation, the operator searches the manual for the meaning of a trouble message included in the communication or the electronic mail from a management terminal like a monitoring unit that monitors a status of the monitored unit, and classifies the trouble.

(3) The operator assumes a cause of the trouble from the description of the manual.

(4) The operator verifies whether the assumed cause is a true cause or not based on a result of the execution of the command by the monitored unit 41 or the inspection of the history. When the assumed cause is “false” as a result of the verification, the process returns to the above step (3), and assumes a next cause. The operator repeats steps (3) and (4) until when a true cause has been verified.

(5) The operator takes measure against a specified cause.

(6) The operator carries out a post-processing of recording the occurrence and the cause of the trouble. Then, the processing finishes.

The time for waiting for the processing of the job at the above step (1) will be examined below. The waiting time in the conventional workflow (FIG. 15) will be expressed as Ta1, and the processing time in the workflow (FIG. 11) of the present invention will be expressed as Ta1′.

According to the conventional system, the operator cannot start a trouble processing job even when it occurs, while the operator is away from the terminal to carry out an associated operation, as described above. On the other hand, according to the present invention, when a trouble processing job has occurred, the operator can immediately start this processing by suspending the processing of an associated operation. In other words, while the conventional method is a processing without a priority processing, the method shown in FIG. 11 is a processing having a priority processing of a trouble processing. Therefore, Ta1≧Ta1′.

Next, a processing time relating to a trouble processing job at the above-described step (2) will be examined. In this case, an associated operation will not be considered. The waiting time in the conventional workflow will be expressed as Ta2, and the processing time in the workflow of the present invention will be expressed as Ta2′.

According to the conventional system, when a trouble processing job has occurred, the operator searches a manual or an explanation document for the meaning of the trouble message, as described above. Based on this, the operator recognizes a position of the trouble, a seriousness level, possible causes and countermeasures of these causes. On the other hand, according to the present invention, the arranging unit automatically posts a trouble message, as well as a position of the trouble, a seriousness level, possible causes and countermeasures of these causes, to the operator. Therefore, the operator does not need to check the manual or the explanation document, and thus Ta2 ≧Ta2′.

Next, the processing time at steps (3) and (4) will be examined. The waiting time in the conventional workflow will be expressed as Ta34, and the processing time in the work flow of the present invention will be expressed as Ta34′.

According to the conventional workflow, the assumed cause is verified based on a result of the execution of a command by the monitored unit or a history, as described above. On the other hand, according to the workflow of the present invention, the arranging unit has a rule of an analysis procedure corresponding to each trouble message. The arranging unit executes the collection of all data necessary for the analysis, and the arrangement to the operator, at the same time. These are realized based on a request for executing a command for collecting a history held by the arranging unit and a command to the electronic message generating unit. Therefore, the operator can immediately carry out the verification of the assumed causes. In other words, Ta34≧Ta34′.

Regarding the processing time at steps (5) and (6), there is no difference between the processing times Ta5 and Ta6 in the conventional workflow and the processing times Ta5′ and Ta6′ in the workflow of the present invention. In other words, Ta5=Ta5′, and Ta6=Ta6′.

Next, the job processing time of the trouble processing in the conventional workflow is expressed as Ta, and the processing time in the present invention is expressed as Ta′. Then, the following relationships exist.

Ta=Ta1+Ta2+Ta34+Ta5+T6

Ta′=Ta1′+Ta2′+Ta34′+Ta5′+T6′

In this case, Ta1≧Ta1′, Ta2≧Ta2′, Ta34≧Ta34′, Ta5 ≧Ta5′, and Ta6≧Ta6′. Therefore, Ta≧Ta′.

Therefore, according to the present invention, it is possible to execute the trouble-processing job in a shorter time than in the conventional system.

Case (B): When the Operator Requires the Processing by the Engineer

According to the conventional system (see FIG. 15), when the operator cannot complete the processing of a trouble by himself/herself due to a limit of the knowledge of the operator, the operator must ask the engineer for the processing, as described above. In this case, the engineer receives requests for job processing from a plurality of operators. These jobs are entered into the queue 5. Each time when one job has been finished, the engineer takes out a next job from the queue 5, and executes this job at the second stage 6. After the engineer has finished one job, the operator carries out a post-processing of this job at the fifth stage 10. This corresponds to step (6) of the case (A). When the engineer cannot manage the processing of a job, the engineer asks the expert to process this job. The case where the engineer can process a job will be explained below.

The processing of the engineer in the conventional system (see FIG. 15) and in the system of the present invention (see FIG. 11) consists of the following steps respectively.

(1) The engineer takes out a next job from the queue 5 or 27.

(2) The engineer reads the manual and looks for the meaning of the asked trouble message, and classifies the trouble.

(3) The engineer assumes a cause of the trouble from the description of the manual.

(4) The engineer verifies whether the assumed cause is a true cause or not, based on a result of the execution of the command by the monitored unit and the inspection of a history. When the assumed cause is false as a result of the verification, the process returns to step (3), and the engineer assumes a next cause. The engineer repeats the steps (3) and (4) until when a true cause has been verified.

(5) The engineer takes measure against a specified cause.

(6) The engineer posts to the operator about the occurrence of a specified trouble, a cause of the trouble, and a processing carried out. Moreover, the engineer asks the operator to carry out a post-processing of making record or the like. Then, the processing finishes.

In this case, the time taken for completing the processing in the conventional workflow (FIG. 15) is as follows.

T=Ta+Tb+Td

where

Ta=Ta1+Ta2+Ta34

Td=Ta6

Tb=Tb1+Tb2+Tb34+Tb5

Tb1 is a processing time at step (1). Tb2 is a processing time at step (2). Tb34 is a processing time at steps (3) and (4). Tb5 is a processing time at step (5).

On the other hand, according to the workflow (FIG. 11) of the present invention, the arranging unit 47 analyzes the trouble message, and automatically posts the trouble (transmits to the engineer queue 27). Therefore, the time taken for completing the processing is as follows.

T′=Tb′+Td′

where

Tb′=Tb1+Tb2 +Tb34′+Tb5

Td′=Ta6

Tb1 is a processing time at step (1). Tb2 is a processing time at step (2). Tb34′ is a processing time at steps (3) and (4). Tb5 is a processing time at step (5).

As described above, the arranging unit 47 analyzes the trouble message, and posts the cause and the countermeasure. Moreover, the arranging unit 47 automatically collects data that is necessary for the analysis. Therefore, the time necessary for the engineer to analyze the trouble is Tb34≧Tb34′.

T is compared with T′ as follows.

T=Ta1+Ta2+Ta34+Tb1+Tb2+Tb34+Tb5+Tb6

T′=Ta1+Ta2+Ta34′+Tb5+Tb6

Further, as Tb34≧Tb34′, T≧T′.

Therefore, according to the present invention, it is possible to execute the trouble-processing job in a shorter time than in the conventional system.

Case (C): When the Engineer Requires the Processing by the Expert

According to the conventional system (see FIG. 15), when the engineer cannot complete the processing of a trouble by himself/herself due to a limit of the knowledge of the engineer, the engineer must ask the expert for the processing, as described above. In this case, the expert receives requests for job processing from a plurality of engineers. These jobs are entered into the queue 7. Each time when one job has been finished, the expert takes out a next job from the queue 7, and executes this job at the third stage 8. After the expert has finished one job, the operator carries out a post-processing of this job at the fourth stage 9. This corresponds to step (6) of the case (A).

The processing of the expert in the conventional system (see FIG. 15) and in the system of the present invention (see FIG. 11) consists of the following steps respectively.

(1) The expert takes out a next job from the queue 7 or 28.

(2) The expert reads the manual and looks for the meaning of the asked trouble message, and classifies the trouble.

(3) The expert assumes a cause of the trouble from the description of the manual.

(4) The expert verifies whether the assumed cause is a true cause or not, based on a result of the execution of the command by the monitored unit and the inspection of a history. When the assumed cause is false as a result of the verification, the process returns to step (3), and the expert assumes a next cause. The expert repeats the steps (3) and (4) until when a true cause has been verified.

(5) The expert takes measure against a specified cause.

(6) The expert posts to the operator about the occurrence of a specified trouble, a cause of the trouble, and a processing carried out. Moreover, the engineer asks the operator to carry out a post-processing of making record or the like. Then, the processing finishes.

In this case, the time taken for completing the processing in the conventional workflow (FIG. 15) is as follows.

T=Ta+Tb++Tc+Td

where

Ta=Ta1+Ta2+Ta34

Td=Ta6

Tb=Tb1+Tb2+Tb34

Tc=Tc1+Tc2+Tc34+Tc5

Tc1 is a processing time at step (1). Tc2 is a processing time at step (2). Tc34 is a processing time at steps (3) and (4). Tc5 is a processing time at step (5).

On the other hand, according to the workflow of the present invention (see FIG. 11), the arranging unit 47 analyzes the trouble message, and automatically posts the trouble (transmits to the expert queue 28). Therefore, the time taken for completing the processing is as follows.

T′=Tc′+Td′

where

Tc′=Tc1+Tc2+Tc34′+Tc5

Td′=Ta6

Tc1 is a processing time at step (1). Tc2 is a processing time at step (2). Tc34′ is a processing time at steps (3) and (4). Tc5 is a processing time at step (5).

As described above, the arranging unit 47 analyzes the trouble message, and posts the cause and the countermeasure to the expert. Moreover, the arranging unit 47 automatically collects data that is necessary for the analysis. Therefore, the time necessary for the expert to analyze the trouble is Tc34≧Tc34′.

T is compared with T′ as follows.

T=Ta1+Ta2+Ta34+Tb1+Tb2+Tb34+Tc1+Tc2+Tc34+Tc5+Ta6

T′=Tc1+Tc2+Tc34′+Tc5+Ta6

Further, as Tb34≧Tb34′, T≧T′.

Therefore, according to the workflow of the present invention, it is possible to execute the trouble-processing job in a shorter time than in the conventional system.

As explained above, according to the workflow of the present invention, in all the above three cases, it is possible to execute the trouble-processing job in a shorter time than in the conventional system.

Finally, an application example of the present invention will be explained.

The monitored unit was a router manufactured by CISCO SYSTEMS.

The knowledge database (FIG. 3) stores the following data (all texts).

seriousness level: 3

error message: %LINK-3-UPDOWN: Interface [char], changed state to down

cause: There is a possibility that the connected cable has been disconnected, or the connected device has been powered off or rebooted.

countermeasure: There is a possibility that the speed and full and half-duplex communication conditions are in error, or have been erroneously recognized. Fix the communication conditions.

trouble analysis route: [SHELL] “show interface”

When a trouble has occurred in the monitored unit, the monitored unit outputs a next error message (text) to the console port.

%LINK-3-UPDOWN: Interface Etherl, changed state to down

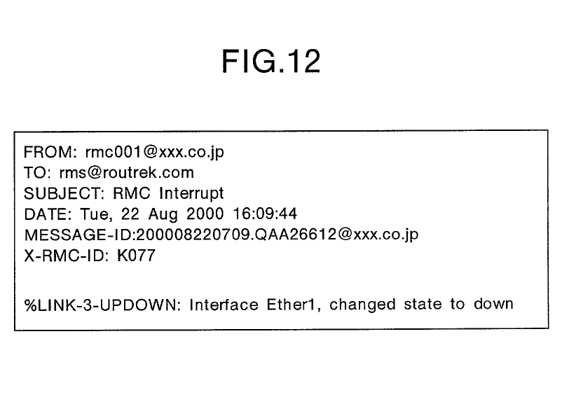

The electronic message generating unit 42 obtains this error message, and creates a mail statement shown in FIG. 7 and the next message (see FIG. 12), and then transmits these to the arranging unit 47 by electronic mail.

In FIG. 12, 200008220709.QAA2661@xxx.co.jp is a message identifier for uniquely identifying the electronic mail. This is a header generally used in the electronic mail. K077 is a unit number. This is a header of the electronic mail particularly added for the present processing. The row of the %LINK—is a mail statement. At the portion of %A-B-C:, A represents a trouble portion, B represents a seriousness level (as registered in the knowledge database (FIG. 3)). C represents a classification. Interface—and after this portion is an error message statement. The message searching mechanism 64 (FIG. 2) of the arranging unit 47 receives the electronic mail, and searches the knowledge database 65 using the error message statement as a key. As a result of the searching, the following information has been obtained. seriousness level: 3

error message: %LINK-3-UPDOWN: Interface Etherl, changed state to down

cause: There is a possibility that the connected cable has been disconnected, or the connected device has been powered off or rebooted.

countermeasure: There is a possibility that the speed and full and half-duplex communication conditions are in error, or have been erroneously recognized. Fix the communication conditions.

trouble analysis route: [SHELL] “show interface”

The arrangement destination determining mechanism 62 of the arranging unit 47 searches the arrangement database 63 based on the above seriousness level and the current time, and obtains a trouble postal destination address (for example, abc@tokyo.co.jp).

The analysis rule executing mechanism 66 of the arranging unit 47 carries out the following work based on the information of the above “trouble analysis rule”.

(I) The trouble analysis rule: [SHELL] “show interface” means to execute the “show interface” command using the monitored unit command execution function of the electronic message generating unit 42. The electronic message generating unit 42 requests the electronic mail creating mechanism 70 to create and transmit an electronic mail for executing the above command to the electronic message generating unit 42.

(II) Having received the above electronic mail, the electronic message generating unit 42 executes the “show interface” command to the monitored unit 41. (Of course, the monitored unit has been designed to make response when the user has input a command. The “show interface” command is one of commands that the monitored unit receives.) The electronic message generating unit 42 obtains information (a character string that the monitored unit outputs as a response to the command) relating to the interface status of the monitored unit, and posts to the arranging unit by electronic mail.

(III) The electronic mail receiving mechanism 60 understands that the received mail is “command response (execution result) to the monitored unit” by referring to the mail title (Subject:), and delivers this mail to the analysis rule executing mechanism 66.

(IV) The analysis rule executing mechanism 66 delivers a result of the execution to the electronic mail creating mechanism 70 and the history recording mechanism 68.

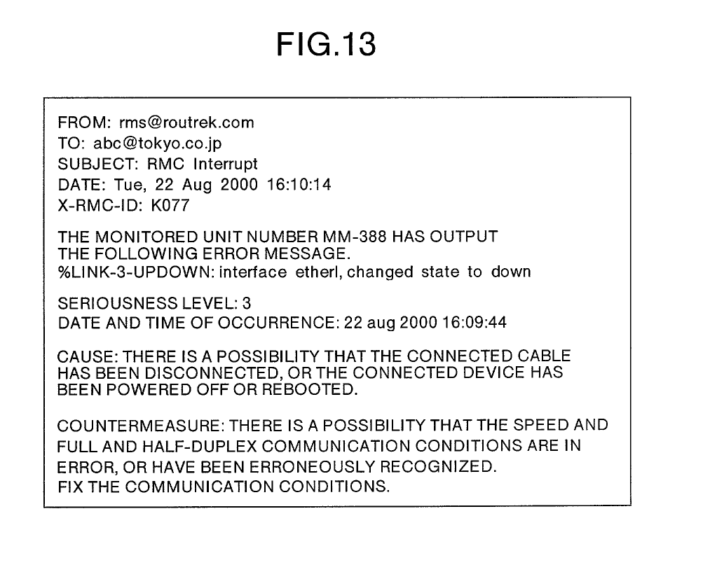

The electronic mail creating mechanism 70 creates an electronic mail (refer to FIG. 13), based on the information obtained in the processing so far carried out and a monitored unit number obtained by searching the database (FIG. 6) of the arranging unit using the unit number (KO77) as a key. Then, the electronic mail transmitting mechanism 67 transmits this electronic mail to a suitable manager (for example, abc@tokyo.co.jp).

“From: rms@routreck.com

To: abc@tokyo.co.jp

Subject: RMC Interrupt

Date: Tue, Aug. 22, 2000 16:10:14

X-Rmc-Id: K077

The monitored unit number MM-388 has output the following error message.

%LINK-3-UPDOWN: Interface Etherl, changed state to down

seriousness level: 3

date and time of occurrence: Aug. 22, 2000 16:09:44

cause: There is a possibility that the connected cable has been disconnected, or the connected device has been powered off or rebooted.

countermeasure: There is a possibility that the speed and full and half-duplex communication conditions are in error, or have been erroneously recognized. Fix the communication conditions.”

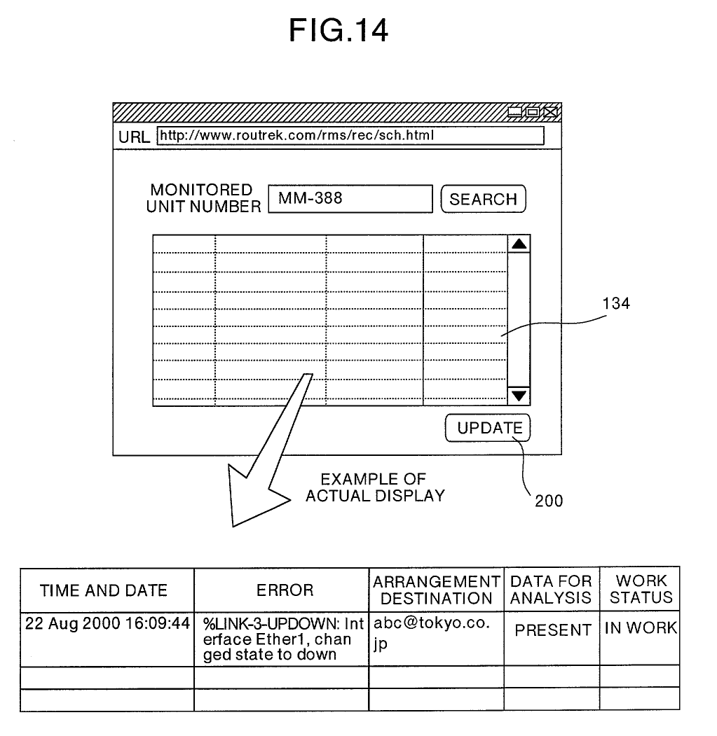

The manager who has received the above mail can read the past historical trouble record of the monitored unit (MM-388) in the Web browser as shown in FIG. 14.

In FIG. 14, when an update button 200 has been depressed, it is possible to edit the text of the work status (field 85) displayed on a countermeasure display column 134, thereby to update the contents of the history database (see FIG. 4). For example, it is possible to update the history database by rewriting the work status displayed as “in work” into “complete Aug. 23, 2000”.

When a “present” cell of the above “data for analysis” column is clicked, a text of a result of the execution of the “show interface” command is displayed on another window.

A computer program containing instructions which when executed on a computer causes the computer to perform the method according to the present invention is recorded on computer readable-recording medium. This computer readable-recording medium may be a floppy disk or a CD-ROM. Alternately the program may be stored at a server and the program may be downloaded when required. Otherwise, the program may be executed while it is at the server, i.e. without downloading from the server.

As explained above, according to the present invention, a cause of a trouble and a countermeasure are added to a message from the monitored unit, and an electronic message created as a result is posted in real time. Based on this method, it is possible to reduce the time required for the operator to analyze the trouble and arrange the work. Further, it is possible to dynamically change making arrangement to a plurality of managers and maintenance persons according to a seriousness level of each trouble so that the troubles are handled in parallel. As a result, it is possible to reduce the time required for recovering from troubles.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A network management system comprising:
a monitored unit that may generate trouble in a network, said monitored unit transmitting a first electronic message indicating its own status;
an electronic message generating unit that receives the message from said monitored unit and generates a second electronic message based on the message from said monitored unit; and
an arranging unit which
receives the electronic message from said electronic message generating unit,
analyzes the contents of this electronic message, determines a seriousness level of the trouble,
determines a destination of a third electronic message for informing about the trouble based on the determined seriousness level, time and date of occurrence of the trouble,
determines causes and/or countermeasures of the trouble,
creates the third electronic message that contains information that trouble has occurred, causes and/or countermeasures of the trouble, and
transmits the third electronic message to the determined destination.

2. The network management system according to claim 1, wherein said electronic message generating unit monitors the status of said monitored unit, creates the second electronic message immediately after detecting a trouble, and transmits the second electronic message to said arranging unit in the form of an electronic mail.

3. The network management system according to claim 1, wherein said electronic message generating unit has a function of making said monitored unit execute a command according to a request from a remote place, thereby to understand or detect a status of said monitored unit.

4. The network management system according to claim 1, wherein said arranging unit has a function of presenting a result of an analysis carried out based on the collected data, to an operator or other relevant persons.

5. The network management system according to claim 1, wherein said arranging unit has a database that contains information about a connection relationship between said monitored unit and said electronic message generating unit.

6. An arranging unit comprising:
a knowledge database which stores information about cause, countermeasure, and trouble analysis rules corresponding to the contents of an electronic message regarding a trouble or an alarm posted from a monitored unit that can generate a trouble in a network;
a history database which stores information about history of messages generated in the past from the monitored unit; and
an arrangement database which stores information about a plurality of postal destinations that are different depending on an occurrence time of the trouble or an alarm and the contents of the message.

7. The arranging unit according to claim 6, further comprising a display screen which displays the contents of the history database.

8. The arranging unit according to claim 6, wherein said monitored unit posts the electronic message in the form of an electronic mail, and said arranging unit further comprises:
a message searching unit which searches the knowledge database, thereby determining a seriousness level, possible causes and countermeasures, and an accompanying analysis rule of a trouble respectively, based on the content of the electronic mail from said monitored unit;
an arrangement destination determining unit which determines an arrangement destination of a work by searching the arrangement database, based on the seriousness level determined by said message searching unit, and the current time;
an analysis rule executing unit which executes the trouble analysis rule determined by said message searching unit, collects data necessary for the analysis of the trouble and/or estimating a cause; and
an electronic mail creating unit which creates an electronic mail to be posted to the arrangement destination, based on information from said message searching unit, arrangement destination determining unit, and analysis rule executing unit.

9. A network management method comprising the steps of:
monitoring a status of a monitored unit that can generate a trouble in a network;
generating a first electronic message based on the monitored status of said monitored unit;
determining a seriousness level of the trouble by analyzing the contents of the first electronic message;
determining a destination of a second electronic message for informing about the trouble based on the determined seriousness level, time and date of occurrence of the trouble;
determining causes and/or countermeasures of the trouble;
creating the third electronic message that contains information that trouble has occurred, causes and/or countermeasures of the trouble; and
transmitting the third electronic message to the determined destination.

10. A computer readable medium for storing instructions, which when executed on a computer, causes the computer to perform the steps of:
monitoring a status of a monitored unit that can generate a trouble in a network;
generating a first electronic message based on the monitored status of said monitored unit;
determining a seriousness level of the trouble by analyzing the contents of the first electronic message;
determining a destination of a second electronic message for informing about the trouble based on the determined seriousness level, time and date of occurrence of the trouble;
determining causes and/or countermeasures of the trouble;
creating the third electronic message that contains information that trouble has occurred, causes and/or countermeasures of the trouble; and
transmitting the third electronic message to the determined destination.
